(19) United States
(12) Patent Application Publication
(10) Pub. No.: US 2011/0304541 A1
(43) Pub. Date: Dec. 15, 2011

(54) METHOD AND SYSTEM FOR DETECTING GESTURES

(76) Inventor: Navneet Dalal, Menlo Park, CA (US)

(21) Appl. No.: 13/159,379

(22) Filed: Jun. 13, 2011

Related U.S. Application Data
(60) Provisional application No. 61/353,965, filed on Jun. 11, 2010.

(51) Int. Cl. G06F 3/033

(52) U.S. Cl. 345/158

(57) ABSTRACT

A method and system for detecting user interface gestures that includes obtaining an image from an imaging unit; identifying object search area of the images; detecting at least a first gesture object in the search area of an image of a first instance; detecting at least a second gesture object in the search area of an image of at least a second instance; and determining an input gesture from an occurrence of the first gesture object and the at least second gesture object.

### CROSS-REFERENCE TO RELATED APPLICATIONS

This application claims the benefit of U.S. Provisional Application No. 61/353,965, filed 11 Jun. 2010, titled “Hand gesture detection system” which is incorporated in its entirety by this reference.

### TECHNICAL FIELD

This invention relates generally to the user interface field, and more specifically to a new and useful method and system for detecting gestures in the user interface field.

### BACKGROUND

There have numerous advances in recent years in the area of user interfaces. Touch sensors, motion sensing, motion capture, and other technologies have enabled tracking user movement. Such new techniques, however, often require new and often expensive devices or components to enable a gesture based user interface. For these techniques to enable even simple gestures require considerable processing capabilities. More sophisticated and complex gestures require even more processing capabilities of a device, thus limiting the applications of gesture interfaces. Furthermore the amount of processing can limit the other tasks that can occur at the same time. Additionally, these capabilities are not available on many devices such as mobile devices were such dedicated processing is not feasible. Additionally, the current approaches often leads to a frustrating lag between a gesture of a user and the resulting action in an interface. Another limitation of such technologies is that they are designed for limited forms of input such as gross body movement. Detection of minute and intricate gestures such as finger gestures are not feasible for commercial products. Thus, there is a need in the user interface field to create a new and useful method and system for detecting gestures. This invention provides such a new and useful method and system.

### BRIEF DESCRIPTION OF THE FIGURES

FIG. 1 is a schematic representation of a method of a preferred embodiment;

FIG. 2 is detailed flowchart representation of a obtaining images of a preferred embodiment;

FIG. 3 is a flowchart representation of detecting a motion region of a preferred embodiment;

FIGS. 4A and 4B a exemplary representations of gesture object configurations;

FIG. 5 is a flowchart representation of computing feature vectors of a preferred embodiment;

FIG. 6 is a flowchart representation of determining a gesture input;

FIG. 7 is a schematic representation of tracking motion of an object;

FIG. 8 is a flowchart representation of predicting object motion;

FIG. 9 is a schematic representation of transitioning gesture detection process between processing units;

FIG. 10 is a schematic representation of applying the method for advertising;

FIGS. 11 and 12 are schematic representations of exemplary keyboard input techniques;

FIG. 13 is a schematic representation of method of a second preferred embodiment; and

FIG. 14 is a schematic representation of a system of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

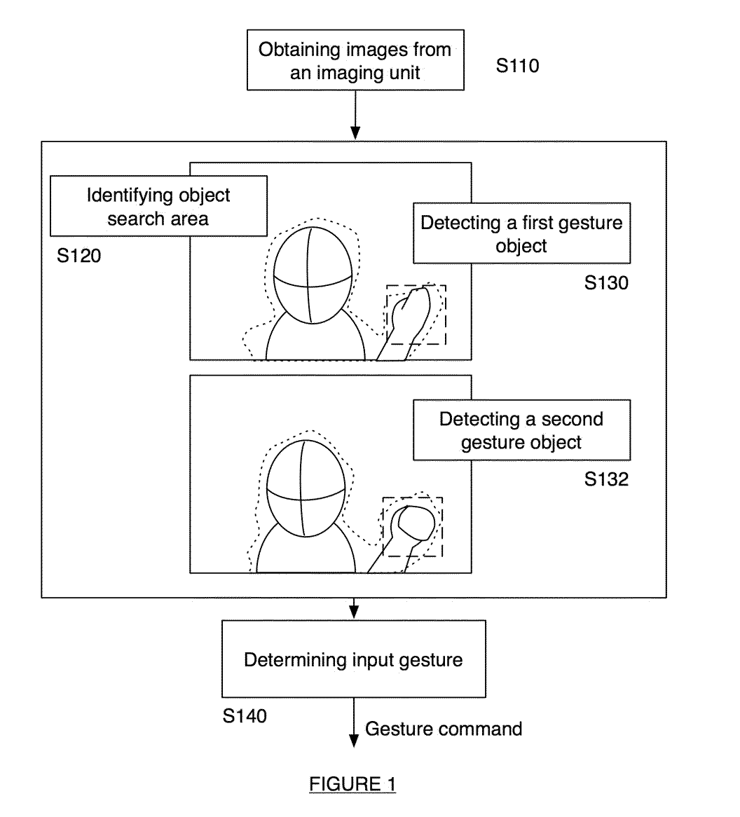

As shown in FIG. 1, a method for detecting gestures of a preferred embodiment includes the steps of obtaining images from an imaging unit Silo; identifying object search area of the images S120; detecting a first gesture object in the search area of an image of a first instance S130; detecting a second gesture object in the search area of an image of at least a second instance S132; and determining an input gesture from the detection of the first gesture object and the at least second gesture object S140. The method functions to enable an efficient gesture detection technique using simplified technology options. The method primarily utilizes object detection as opposed to object tracking (though object tracking may additionally be used). A gesture is preferably characterized by a real world object transitioning between at least two configurations. The detection of a gesture object in one configuration in at least one image frame may additionally be used as gesture. The method can preferably identify images of the object (i.e., gesture objects) while in various stages of configurations. For example, the method can preferably be used to detect a user flicking their fingers from side to side to move forward or backwards in an interface. Additionally, the steps of the method are preferably repeated to identify a plurality of types of gestures. These gestures may be sustained gestures (e.g., such as a thumbs-up), change in orientation of a physical object (e.g., flicking fingers side to side), combined object gestures (e.g., using face and hand to signal a gesture), gradual transition of gesture object orientation, changing position of detected object, and any suitable pattern of detected/tracked objects. The method may be used to identify a wide variety of gestures and types of gestures through one operation process. The method is preferably implemented through an imaging unit capturing video such as a RGB digital camera like a web camera or a camera phone, but may alternatively be implemented by any suitable imaging unit such as stereo camera, 3D scanner, or IR camera. The method preferably leverages image based object detection algorithms, which preferably enables the method to be used for gestures involving arbitrarily complex gestures. For example, the method can preferably detect gestures involving finger movement and hand position without sacrificing operation efficiency or increasing system requirements. One exemplary application of the method preferably includes being used as a user interface to a computing unit such as a personal computer, a mobile phone, an entertainment system, or a home automation unit. The method may be used for computer input, attention monitoring, mood monitoring, and/or any suitable application. The system implementing the method can preferably be activated by clicking a button, using an ambient light sensor to detect a user presence, or any suitable technique for activating and deactivating the method.

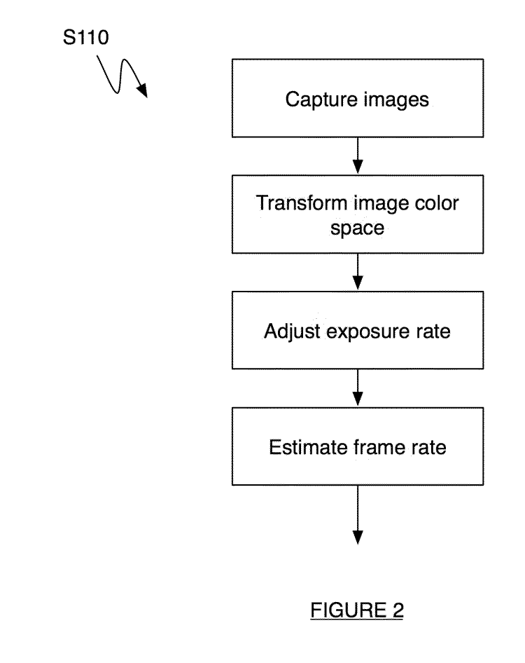

Step S110, which includes obtaining images from an imaging unit S110, functions to collect data representing physical presence and actions of a user. The images are the source from which gesture input will be generated. The imaging unit preferably captures image frames and stores them. Depending upon ambient light and other lighting effects such as exposure or reflection, it optionally performs pre-processing of images for later processing stages (shown in FIG. 2). The camera is preferably capable of capturing light in the visible spectrum like a RGB camera, which may be found in web cameras, web cameras over the internet or local wifi/home/office networks, digital cameras, smart phones, tablet computers, and other computing devices capable of capturing video. Any suitable imaging system may alternatively be used. A single unique camera is preferably used, but a combination of two or more cameras may alternatively be used. The captured images may be multi-channel images or any suitable type of image. For example, one camera may capture images in the visible spectrum, while a second camera captures near infrared spectrum images. Captured images may have more than one channel of image data such as RGB color data, near infra-red channel data, a depth map, or any suitable image representing the physical presence of a objects used to make gestures. Depending upon historical data spread over current and prior sessions, different channels of a source image may be used at different times. Additionally, the method may control a light source for when capturing images. Illuminating a light source may include illuminating a multi spectrum light such as near infra-red light or visible light source. One or more than one channel of the captured image may be dedicated to the spectrum of a light source. The captured data may be stored or alternatively used in real-time processing. Pre-processing may include transforming image color space to alternative representations such as Lab, Luv color space. Any other mappings that reduce the impact of exposure might also be performed. This mapping may also be performed on demand and cached for subsequent use depending upon the input needed by subsequent stages. Additionally or alternatively, preprocessing may include adjusting the exposure rate and/or framerate depending upon exposure in the captured images or from reading sensors of an imaging unit. The exposure rate may also be computed by taking into account other sensors such as strength of GPS signal (e.g., providing insight into if the device is indoor or outdoor), time of the day or year. This would typically impact frame rate of the images. The exposure may alternatively be adjusted based on historical data. In addition to capturing images, an instantaneous frame rate is preferably calculated and stored. This frame rate data may be used to calculate and/or map gestures to a reference time scale.

Step S120, which includes identifying object search area of the images, functions to determine at least one portion of an image to process for gesture detection. Identifying an object search area preferably includes detecting and excluding background areas of an image and/or detecting and selecting motion regions of an image. Additionally or alternatively, past gesture detection and/or object detection may be used to determine where processing should occur. Identifying object search area preferably reduces the areas where object detection must occur thus decreasing runtime computation. The search area may alternatively be the entire image. A search area is preferably identified for each image of obtained images, but may alternatively be used for a group plurality of images.

When identifying an object search area, a background estimator module preferably creates a model of background regions of an image. The non-background regions are then preferably used as object search areas. Statistics of image color at each pixel are preferably built from current and prior images frames. Computation of statistics may use mean color, color variance, or other methods such as median, weighted mean or variance, or any suitable parameter. The number of frames used for computing the statistics is preferably dependent on the frame rate or exposure. The computed statistics are preferably used to compose a background model. In another variation, a weighted mean with pixels weighted by how much they differ from an existing background model may be used. These statistical models of background area are preferably adaptive (i.e., the background model changes as the background changes). A background model will preferably not use image regions where motion occurred to update its current background model. Similarly, if a new object appears and then does not move for a number of subsequent frames, the object will preferably in time be regarded as part of the background. Additionally or alternatively, creating a model of background regions may include applying an operator over a neighborhood image region of a substantial portion of every pixel, which functions to create a more robust background model. The span of a neighborhood region may change depending upon current frame rate. A neighborhood region can increase when frame rate is low in order to build more a robust and less noisy background model. One exemplary neighborhood operator may include a Gaussian kernel. Another exemplary neighborhood operator is a super-pixel based neighborhood operator that computes (within a fixed neighborhood region) which pixels are most similar to each other and group them in one super-pixel. Statistics collection is then preferably performed over only those pixels that classify in the same super-pixel as the current pixel. One example of super-pixel based method is to alter behavior if the gradient magnitude for a pixel is above a specified threshold.

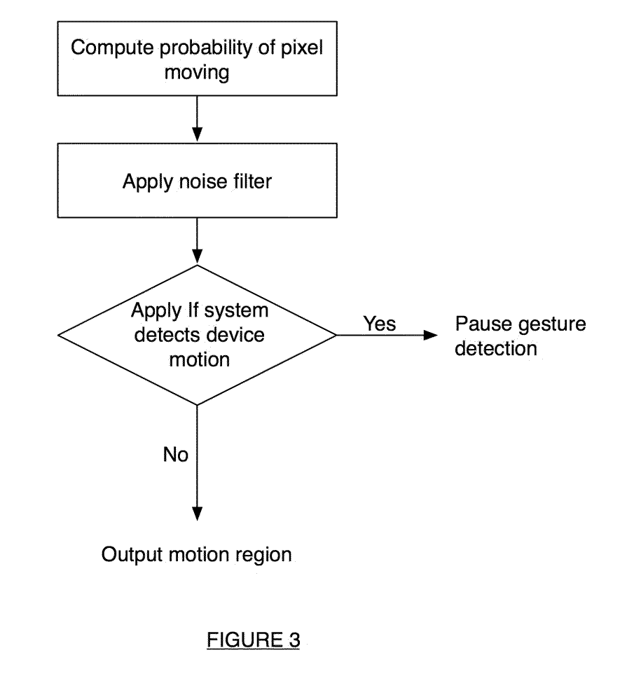

Additionally or alternatively, identifying an object search area may include detecting a motion region of the images. Motion regions are preferably characterized by where motion occurred in the captured scene between two image frames. The motion region is preferably a suitable area of the image to find gesture objects. A motion region detector module preferably utilizes the background model and a current image frame to determine which image pixels contain motion regions. As shown in FIG. 3, detecting a motion region of the images preferably includes performing a pixel-wise difference operation and computing probability a pixel has moved. The pixel-wise difference operation is preferably computed using the background model and a current image. Motion probability may be calculated in a number of ways. In one variation, a Gaussian kernel (exp(−SSD(x_{current}, x_{background})/s)) is preferably applied to a sum of square difference of image pixels. Historical data may additionally be down weighted as motion moves further away in time from the current frame. In another variation, a sum of square difference (SSD function) may be computed over any one channel or any suitable combination of channels in the image. A sum of absolute difference per channel function may alternatively be used in place of the SSD function. Parameters of the operation may be fixed or alternatively adaptive based on current exposure, motion history, and ambient light and user preferences. In another variation, a conditional random field based function may be applied where the computation of each pixel to be background uses pixel difference information from neighborhood pixels, image gradient, and motion history for a pixel, and/or the similarity of a pixel compared to neighboring pixels. This conditional random field based function is preferably substantially similar to the one described in (1) “Robust Higher Order Potentials for Enforcing Label Consistency”, 2009, by Kohli, Ladicky, and Torr and (2) “Dynamic Graph Cuts and Their Applications in Computer Vision”, 2010, by Kohli and Torr, which are both incorporated in their entirety by this reference. The probability image may additionally be filtered for noise. In one variation, noise filtering may include running a motion image through a morphological erosion filter and then applying a dilation or Gaussian smoothing function followed by applying a threshold function. Different algorithms may alternatively be used. Motion region detection is preferably used in detection of an object, but may additionally be used in the determination of a gesture. If the motion region is above a certain threshold the method may pause gesture detection. For example, when moving an imaging unit like a smartphone or laptop, the whole image will typically appear to be in motion. Similarly motion sensors of the device may trigger a pausing of the gesture detection.

Steps S130 and S132, which include detecting a first gesture object in the search area of an image of a first instance and detecting a second gesture object in the search area of an image of at least a second instance, function to use image object detection to identify objects in at least one configuration. The first instance and the second instance preferably establish a time dimension to the objects that can then be used to interpret the images as a gesture input in Step S140. The system may look for a number of continuous gesture objects. A typical gesture may take approximately 300 milliseconds to perform and span approximately 3-10 frames depending on image frame rate. Any suitable length of gestures may alternatively be used. This time difference is preferably determined by the instantaneous frame rate, which may be estimated as described above. Object detection may additionally use prior knowledge to look for an object in the neighborhood of where the object was detected in prior images.

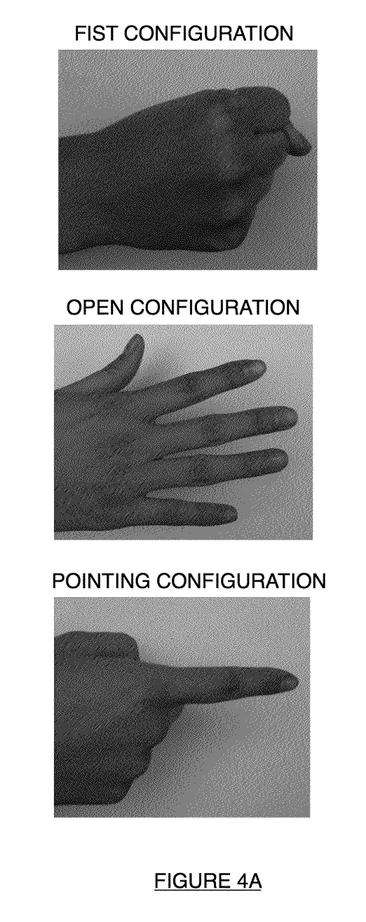

A gesture object is preferably a portion of a body such as a hand or a face, but may alternatively be a device, instrument or any suitable object. Similarly, the user is preferably a human but may alternatively be any animal or device capable of creating visual gestures. Preferably a gesture involves an object(s) in a set of configuration. The gesture object is preferably any object and/or configuration of an object that may be part of a gesture. A general presence of an object (e.g., a hand), a unique configuration of an object (e.g., a particular hand position viewed from a particular angle) or a plurality of configurations may distinguish a gesture object (e.g., various hand positions viewed generally from the front). Additionally, a plurality of objects may be detected (e.g., hands and face) for any suitable instance. In one embodiment, as shown in FIG. 4A, detection of the hand in a plurality of configurations is performed. In another embodiment, as shown in FIG. 4B, detection of the face, and facial expressions, direction of attention, or other gestures are preferably detected. In another embodiment, hands and the face are detected for cooperative gesture input. As described above, a gesture is preferably characterized by an object transitioning between two configurations. This may be holding a hand in a first configuration (e.g., a first) and then moving to a second configuration (e.g., fingers spread out). Each configuration that is part of a gesture is preferably detectable. A detection module preferably uses a machine learning algorithm over computed features of an image. The detection module may additionally use online leaning which functions to adapt gesture detection to a specific user. Identifying the identity of a user through face recognition may provide additional adaption of gesture detection. Any suitable machine learning or detection algorithms may alternatively be used. For example, the system may start with an initial model for face detection, but as data is collected for detection from a particular user the model may be altered for better detection of the particular face of the user. The first gesture object and the second gesture object are typically the same physical object in different configurations. There may be any suitable number of detected gesture objects. For example, a first gesture object may be a hand in a first and a second gesture object may be an opened hand. Alternatively, the first gesture object and the second gesture object may be different physical objects. For example, a first gesture object may be the right hand in one configuration, and the second gesture object may be the left hand in a second configuration. Similarly gesture object may be the combination of multiple physical objects such as multiple hands, objects, faces and may be from one or more users. For example, such gesture objects may include holding hands together, putting hand to mouth, holding both hands to side of face, holding an object in particular configuration or any suitable detectable configuration of objects. As will be described in Step S140, there may be numerous variations in interpretation of gestures.

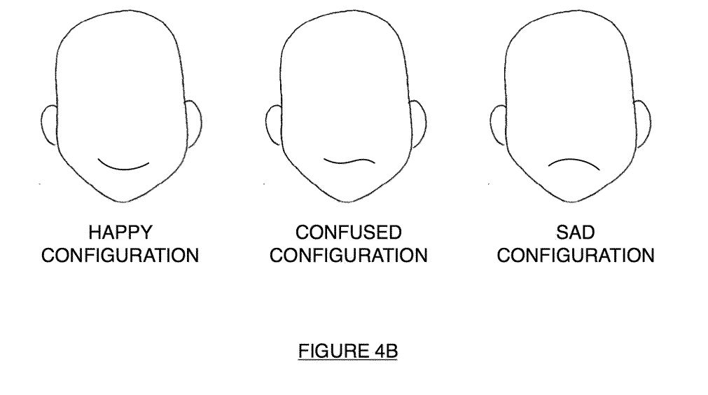

Additionally, an initial step for detecting a first gesture object and/or detecting a second gesture object may be computing feature vectors S144, which functions as a general processing step for enabling gesture object detection. The feature vectors can preferably be used for face detection, face tracking, face recognition, hand detector, hand tracking, and other detection processes, as shown in FIG. 5. Other steps may alternatively be performed to detect a gesture objects. Pre-computing a feature vector in one place can preferably enable a faster overall computation time. The feature vectors are preferably computed before performing any detection algorithms and after any pre-processing of an image. Preferably, an object search area is divided into potentially overlapping blocks of features where each block further contains cells. Each cell preferably aggregates pre-processed features over the span of the cell through use of a histogram, by summing, by Haar wavelets based on summing/differencing or based on applying alternative weighting to pixels corresponding to cell span in the preprocessed features, and/or by any suitable method. Computed feature vectors of the block are then preferably normalized individually or alternatively normalized together over the whole object search area. Normalized feature vectors are preferably used as input to a machine learning algorithm for object detection, which is in turn used for gesture detection. The feature vectors are preferably a base calculation that converts a representation of physical objects in an image to a mathematical/numerical representation. The feature vectors are preferably usable by plurality of types of object detection (e.g., hand detection, face detection, etc.), and the feature vectors are preferably used as input to specialized object detection. Feature vectors may alternatively be calculated independently for differing types of object detection. The feature vectors are preferably cached in order to avoid re-computing feature vectors. Depending upon a particular feature, various caching strategies may be utilized, some can share feature computation. Computing feature vectors is preferably performed for a portion of the image, such as where motion occurred, but may alternatively be performed for a whole image. Preferably, stored image data and motion regions is analyzed to determine where to compute feature vectors.

Static, motion, or combination of static and motion feature sets as described above or any alternative feature vectors sets may be used when detecting a gesture object such as a hand or a face. Machine learning algorithms may additionally be applied such as described in Dalal, Finding People in Images and Videos, 2006; Dalal & Triggs, Histograms of Oriented Gradients for Human Detection, 2005; Felzenszwalb P. F., Girshick, McAllester, & Ramanan, 2009; Felzenszwalb, Girshick, & McAllester, 2010; Maji & Berg, Max-Margin Additive Classifiers for Detection, 2009; Maji & Malik, Object Detection Using a Max-Margin Hough Tranform; Maji, Berg, & Malik, Classification using Intersection Kernel support vector machine is efficient, 2008; Schwartz, Kembhavi, Harwood, & Davis, 2009; Viola & Jones, 2004; Wang, Han, & Yan, 2009, which are incorporated in their entirety by this reference. Other machine learning algorithms may be used which directly takes as input computed feature vectors over image regions and/or plurality of image regions over time or takes as input simple pre-processed image regions after module Silo without computing feature vectors to make predictions such as described in LeCun, Bottou, Bengio and Haffner, Gradient-based learning applied to document recognition, in Proceedings of IEEE, 1998; Bengio, Learning deep architectures for AI, in Foundations and Trends in Machine Learning, 2009; Hinton, Osindero and Teh, A fast learning algorithm for deep belief nets, in Neural Computation, 2006; Hinton and Salakhutdinov, Reducing the dimensionality of data with neural networks, in Science, 2006; Zeiler, Krishnan, Taylor and Fergus, Deconvolutional Networks, in CVPR, 2010; Le, Zou, Yeung, Ng, Learning hierarchical spatio-temporal features for action recognition with independent subspace analysis, in CVPR, 2011; Le, Ngiam, Chen, Chia, Koh, Ng, Tiled Convolutional Neural Networks, in NIPS, 2010. These techniques or any suitable technique may be used to determine the presence of a hand, face, or other suitable object.

Depending upon the task, the feature vector may be computed only for motion regions and/or in a neighborhood region of last known position of an object (e.g., hand, face) or any other relevant target region. Different features are preferably computed for hand, face detection, and face recognition. Alternatively, one feature set may be used for any detection or recognition task. Combination of features may additionally be used such as Haar wavelets, SIFT (scale invariant feature transformation), LBP, Co-occurrence, LSS, or HOG (histogram of oriented gradient) as described in “Finding People in Images and Videos”, 2006 by Dalal, and “Histograms of Oriented Gradients for Human Detection”, 2005 by Dalal and Triggs, which are incorporated in their entirety by this reference. Motion features, such as motion HOG as described in “Human Detection using Oriented Histograms of Flow and Appearance”, 2006 by Dalal, Triggs, & Schmid, and in “Finding People in Images and Videos”, 2006, by Dalal, both incorporated in their entirety by this reference, wherein the motion features depend upon a current frame and a set of images captured over some prior M seconds may also be computed. LBP, Co-occurrence matrices or LSS features can also be extended to use two or more consecutive video frames. Though, any suitable processing technique may be used, these processes and other processes used in the method are preferably implemented through techniques substantially similar to techniques found in the following references:

U.S. Pat. No. 6,711,293, titled “Method and apparatus for identifying scale invariant features in an image and use of same for locating an object in an image”;

U.S. Pat. No. 7,212,651, titled “Detecting pedestrians using patterns of motion and appearance in videos”;

U.S. Pat. No. 7,031,499, titled “Object recognition system”;

U.S. Pat. No. 7,853,072, titled “System and method for detecting still objects in images”;

US Patent Application 2007/0237387, titled “Method for detecting humans in images”;

US Patent Application 2010/0272366, titled “Method and device of detecting object in image and system including the device”;

US Patent Application 2007/0098254, titled “Detecting humans via their pose”;

US Patent Application 2010/0061630, titled “Specific Emitter Identification Using Histogram of Oriented Gradient Features”;

US Patent Application 2008/0166026, titled “Method and apparatus for generating face descriptor using extended local binary patterns, and method and apparatus for face recognition using extended local binary patterns”;

US Patent Application 2011/0026770, titled “Person Following Using Histograms of Oriented Gradients”; and

US Patent Application 2010/0054535, titled “Video Object Classification”. All eleven of these references are incorporated in their entirety by this reference.

These motion features can directly use an image or may use optical flow to establish rough correspondence between consecutive frames of a video. Combination of static image and motion features (preferably computed by combining flow of motion information over time) may also be used.

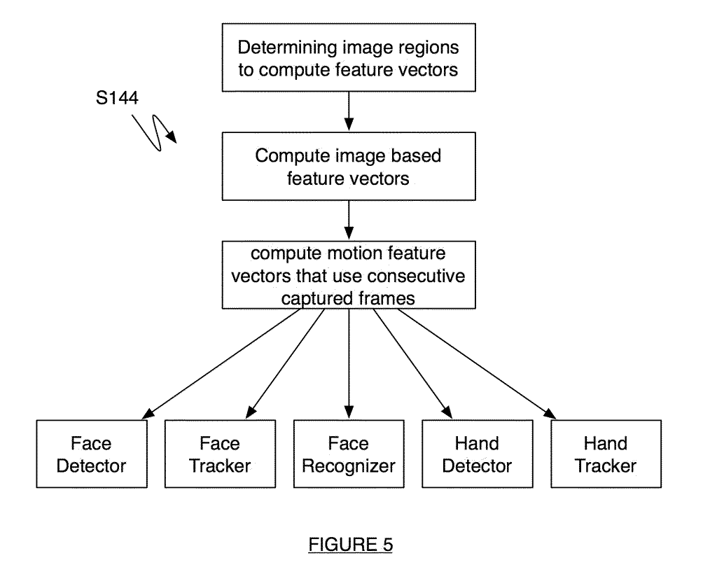

Step S140, which includes determining an input gesture from the detection of the first gesture object and the at least second gesture object, functions to process the detected objects and map them according to various patterns to an input gesture. A gesture is preferably made by a user by making changes in body position, but may alternatively be made with an instrument or any suitable gesture. Some exemplary gestures may include opening or closing of a hand, rotating a hand, waving, holding up a number of fingers, moving a hand through the air, nodding a head, shaking a head, or any suitable gesture. An input gesture is preferably identified through the objects detected in various instances. The detection of at least two gesture objects may be interpreted into an associated input based on a gradual change of one physical object (e.g., change in orientation or position), sequence of detection of at least two different objects, sustained detection of one physical object in one or more orientations, or any suitable pattern of detected objects. These variations preferably function by processing the transition of detected objects in time. Such a transition may involve the changes or the sustained presence of a detected object. One preferred benefit of the method is the capability to enable such a variety of gesture patterns through a single detection process. A transition or transitions between detected objects may be one variation indicate what gesture was made. A transition may be characterized by any suitable sequence and/or positions of a detected object. For example, a gesture input may be characterized by a first in a first instance and then an open hand in a second instance. The detected objects may additionally have location requirements, which may function to apply motion constraints on the gesture. As shown in FIG. 6, there may be various conditions of the object detection that can end gesture detection prematurely. Two detected objects may be required to be detected in substantially the same area of an image, have some relative location difference, have some absolute location change, satisfy a specified rate of location change, or satisfy any suitable location based conditions. In the example above, the first and the open hand may be required to be detected in substantially the same location. As another example, a gesture input may be characterized by a sequence of detected objects gradually transitioning from a first to an open hand. (e.g., a fist, a half open hand, and then an open hand). The method may additionally include tracking motion of an object. In this variation, a gesture input may be characterized by detecting an object in one position and then detecting the object or a different object in a second position. In another variation, the method may detect an object through sustained presence of a physical object in substantially one orientation. In this variation, the user presents a single object to the imaging unit. This object in a substantially singular orientation is detected in at least two frames. The number of frames and threshold for orientation changes may be any suitable number. For example, a thumbs-up gesture may be used as an input gesture. If the method detects a user making a thumbs-up gesture for at least two frames then an associated input action may be made. The step of detecting a gesture preferably includes checking for the presence of an initial gesture object(s). This initial gesture object is preferably an initial object of a sequence of object orientations for a gesture. If an initial gesture object is not found, further input is preferably ignored. If an object associated with at least one gesture is found the method proceeds to detect a subsequent object of gesture. These gestures are preferably detected by passing feature vectors of an object detector combined with any object tracking to a machine learning algorithm that predicts the gesture. A state machine, conditional logic, machine learning, or any suitable technique may be used to determine a gesture. When the gesture is determined an input is preferably transferred to a system, which preferably issues a relevant command. The command is preferably issued through an application programming interface (API) of a program or by calling OS level APIs. The OS level APIs may include generating key and/or mouse strokes if for example there are no public APIs for control. For use within a web browser, a plugin or extension may be used that talks to the browser or tab. Other variations may include remotely executing a command over a network.

In some embodiments, the hands and a face of a user are preferably detected through gesture object detection and then the face object preferably augments interpretation of a hand gesture. In one variation, the intention of a user is preferably interpreted through the face, and is used as conditional test for processing hand gestures. If the user is looking at the imaging unit (or at any suitable point) the hand gestures of the user are preferably interpreted as gesture input. If the user is looking away from the imaging unit (or at any suitable point) the hand gestures of the user are interpreted to not be gesture input. In other words, a detected object can be used as an enabling trigger for other gestures. As another variation of face gesture augmentation, the mood of a user is preferably interpreted. In this variation, the facial expressions of a user serve as a configuration of the face object. Depending on the configuration of the face object, a sequence of detected objects may receive different interpretations. For examples, gestures made by the hands may be interpreted differently depending on if the user is smiling or frowning. In another variation, user identity is preferably determined through face recognition of a face object. Any suitable technique for facial recognition may be used. Once user identify is determined, the detection of a gesture may include applying personalized determination of the input. This may involve loading personalized data set. The personalized data set is preferably user specific object data. A personalized data set could be gesture data or models collected from the identified user for better detection of objects. Alternatively, a permissions profile associated with the user may be loaded enabling and disabling particular actions. For example, some users may not be allowed to give gesture input or may only have a limited number of actions. The user identity may additionally be used to disambiguate gesture control hierarchy. For example, gesture input from a child may be ignored in the presence of adults. Similarly, any suitable type of object may be used to augment a gesture. For example, the left had also augment the gestures or the right hand.

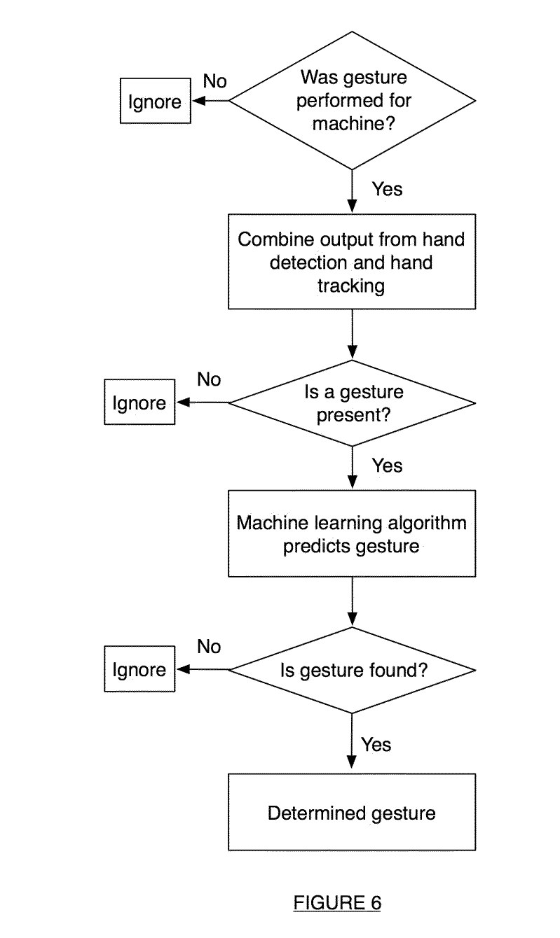

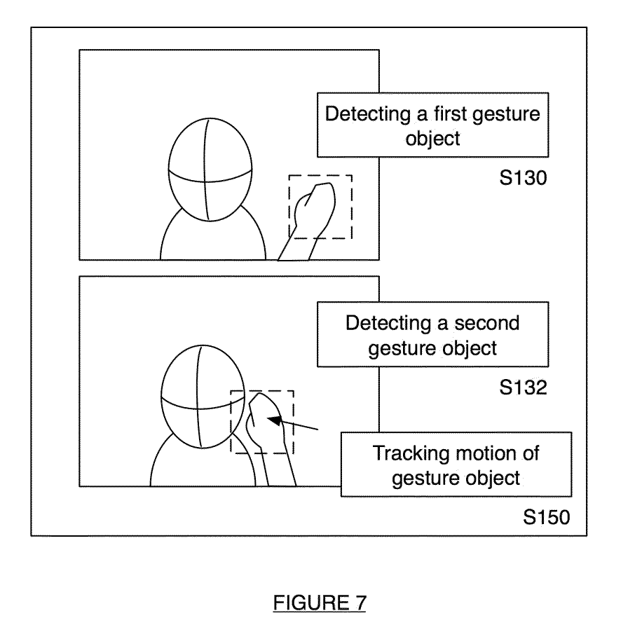

As mentioned about, the method may additionally include tracking motion of an object S150, which functions to track an object through space. For each type of object (e.g., hand or face), the location of the detected object is preferable tracked by identifying the location in the two dimensions (or along any suitable number of dimensions) of the image captured by the imaging unit, as shown in FIG. 7. This location is preferably provided through the object detection process. The object detection algorithms and the tracking algorithms are preferably interconnected/combined such that the tracking algorithm may use object detection and the object detection algorithm may use the tracking algorithm. Alternatively, as shown in FIG. 8, the object location may be predicted through the past locations of the object, immediate history of object motion, motion regions, and/or any suitable predictors of object motion. A post-processing step then preferably determines if the object is found at the predicted location. The tracking of an object may additionally be used in speeding up the object detection process by searching for objects in the neighborhood of prior frames. The tracked object locations can additionally be mapped to a fixed dimension vector space. For example, due to low lighting, if the camera is running at 8 fps, hand locations may be interpolated to N locations (where N be 24, 30, 60 or any other number representing reference number of steps). These N locations preferably represent hand location in prior N*Δt seconds, where Δt is the reference smallest time step. For instance, if reference frame rate is 30 fps, Δt= 1/30 seconds, the module may not forward tracking info of hands to next stage. If sufficient hand motion was not detected in last N*Δt seconds then the tracking information of the object may not be forwarded and the feature vector may not be computed.

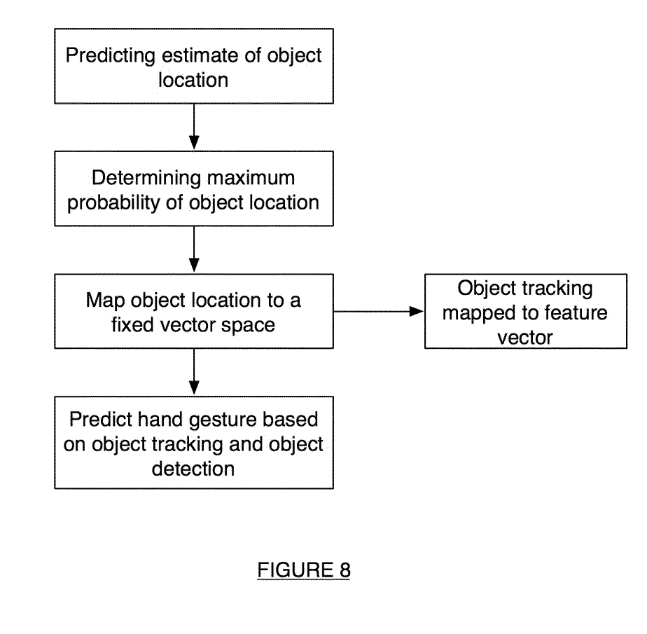

The method of a preferred embodiment may additionally include determining operation load of at least two processing units S160 and transitioning operation to at least two processing units S162, as shown in FIG. 9. These steps function to enable the gesture detection to accommodate processing demands of other processes. The operation of the steps that are preferably transitioned include identifying object search area, detecting at least a first gesture object, detecting at least a second gesture, tracking motion of an object, determining an input gesture to the lowest operation status of the at least two processing units, and/or any suitable processing operation. The operation status of a central processing unit (CPU) and a graphics processing unit (GPU) are preferably monitored but any suitable processing unit may be monitored. Operation steps of the method will preferably be transitioned to a processing unit that does not have the highest demand. The transitioning can preferably occur multiple times in response to changes in operation status. For example, when a task is utilizing the GPU for a complicated task, operation steps are preferably transitioned to the CPU. When the operation status changes and the CPU has more load, the operation steps are preferably transitioned to the GPU. The feature vectors and unique steps of the method preferably enable this processing unit independence. Modern architectures of GPU and CPU units preferably provide a mechanism to check operation load. For a GPU, a device driver preferably provides the load information. For a CPU, operating systems preferably provide the load information. In one variation, the processing units are preferably pooled and the associated operation load of each processing unit checked. In another variation, an event-based architecture is preferably created such that an event is triggered when a load on a processing unit changes or passes a threshold. The transition between processing unit is preferably dependent on the current load and the current computing state. Operation is preferably scheduled to occur on the next computing state, but may alternatively occur midway through a compute state. These steps are preferably performed for the processing units of a single device, but may alternatively or additionally be performed for computing over multiple computing units connected by internet or a local network. For example, smartphones may be used as the capture devices, but operation can be transferred to a personal computer or a server. The transition of operation may additionally factor in particular requirements of various operation steps. Some operation steps may be highly parallelizable and be preferred to run on GPUs while other operation steps may be more memory intensive and be prefer a CPU. Thus the decision to transition operation preferably factors in the number of operations each unit can perform per second, amount of memory available to each unit, amount of cache available to each unit, and/or any suitable operation parameters.

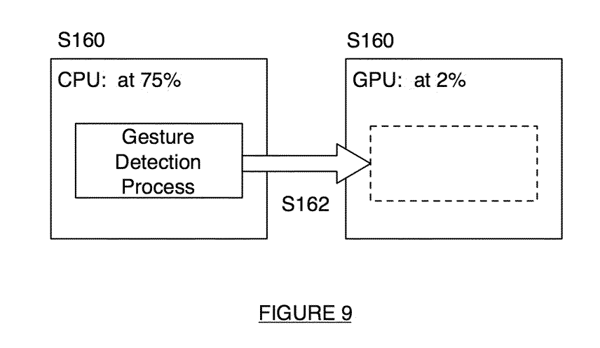

In one exemplary application, as shown in FIG. 10, the method may be used in facilitating monitoring advertisements. In this example, the gesture object preferably includes the head of a user. The method is used to monitor the attention of a user towards a display. This exemplary application preferably includes displaying an advertisement during at least the second instance, and then utilizing the above steps to detect the direction/position of attention of a user. For example, the method preferably detects when the face of a user is directed away from the display unit (i.e., not paying attention) and when the face of a user is directed toward the display unit (i.e., paying attention). In some examples, gestures of the eyes may be performed to achieve finer resolution in where attention is placed such as where on a screen. The method may further include taking actions based on this detection. For example, when attention is applied to the advertisement, an account of the advertiser may be credited for a user viewing of the advertisement. This enables advertising platforms to implement a pay-per-attention advertisement model. The advertisements may additionally utilize other aspects of object detection to determine user demographics such as user gender, objects in the room, style of a user, wealth of the user, type of family, and any suitable trait inferred through object and gesture detection.

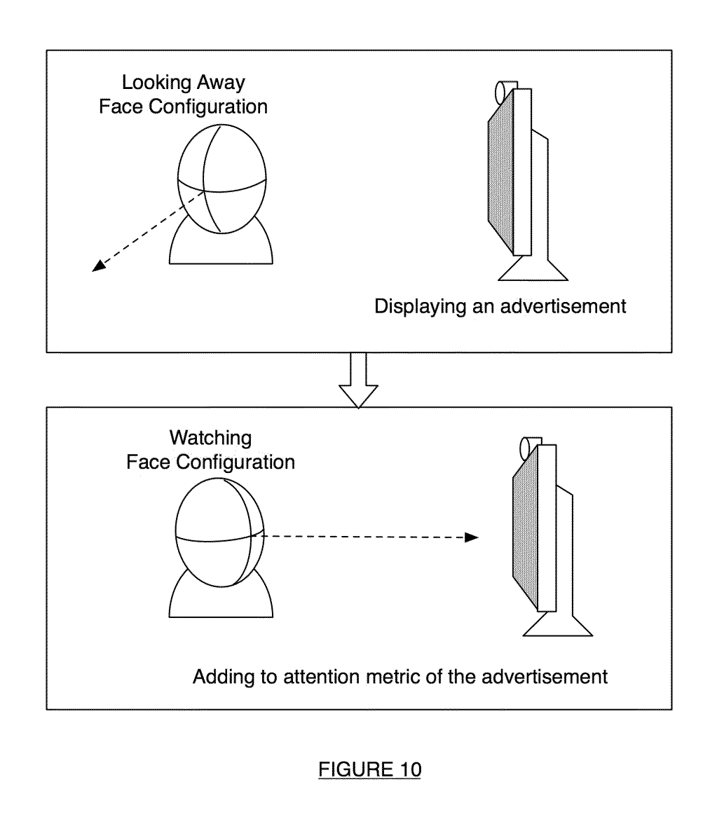

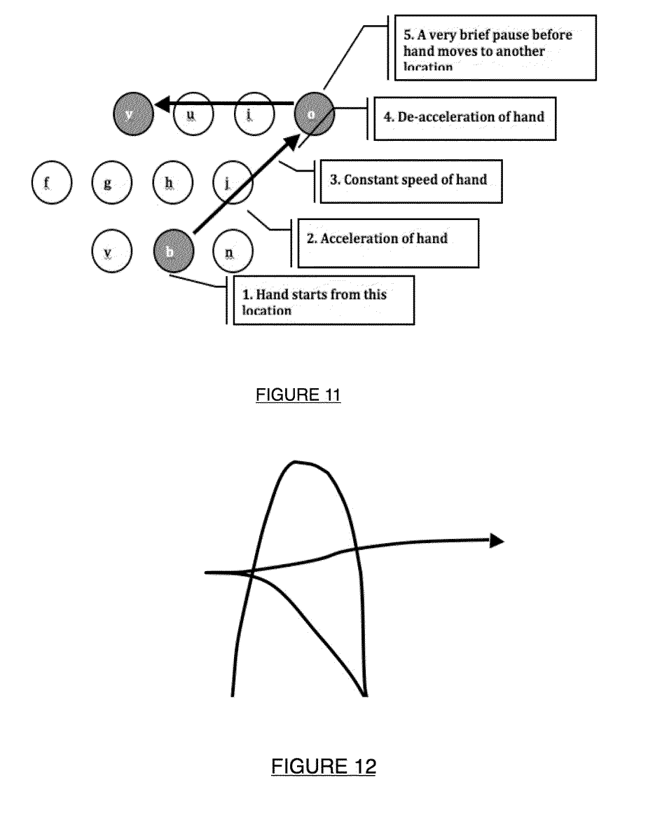

As another exemplary application, the method is preferably used as a controller. The method may be used as a game controller, media controller, computing device controller, home automation controller, automobile automation, and/or any suitable form of controller. Gestures are preferably used to control user interfaces, in-game characters or devices. The method may alternatively be used as any suitable input for a computing device. In one example, the gestures could be used from media control to play, pause, skip forward, skip backward, change volume, and/or any suitable media control action. The gesture input may additionally be used for mouse and/or keyboard like input. Preferably, a mouse and/or key entry mode is enabled through detection of a set object configuration. When the mode is enabled two-dimensional (or three dimensional) tracking of an object is translated to cursor or key entry. In one embodiment a hand in a particular configuration is detected and mouse input is activated. The hand is tracked and corresponds to the displayed position of a cursor on a screen. As the user moves their hand the cursor moves on screen. The scale of detected hand or face may be used to determine the scale and parameters of cursor movement. Multiple strokes associated with mouse input such as left and right clicks may be performed by tapping a hand in the air or changing hand/finger configuration or through any suitable pattern. Similarly, a hand configuration may be detected to enable keyboard input. The user may tap or do some specified hand gesture to tap a key. Alternatively, as shown in FIG. 11, the keyboard input may involve displaying a virtual keyboard and a user swiping a hand to move a cursor from letter to letter of the virtual keyboard. As another exemplary form of keyboard input, as shown in FIG. 12, the user may move hand through the air to simulate writing characters. Alternatively, any suitable user interaction patterns may be used with the gesture input.

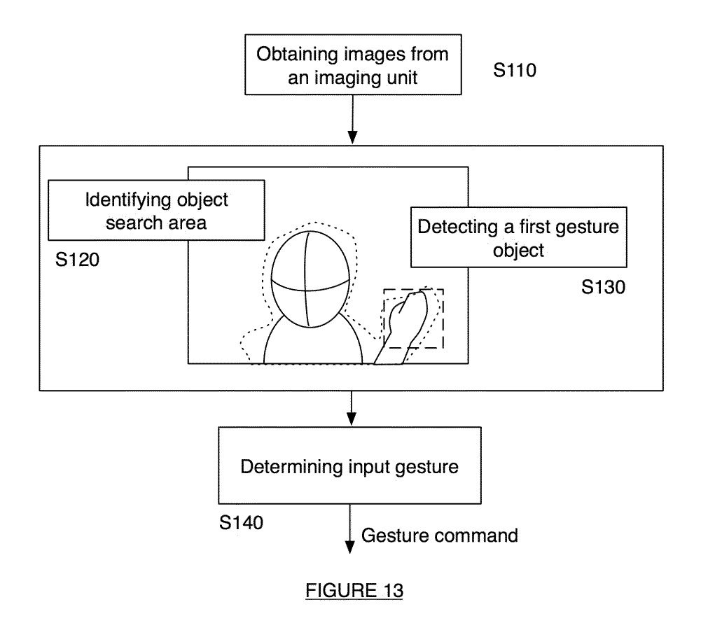

As shown in FIG. 13 method for detecting gestures of a second preferred embodiment includes the steps of obtaining images from an imaging unit; identifying object search area of the images; detecting a first gesture object in the search area of an image of a first instance; and determining an input gesture from the detection of the first gesture object. The method is substantially similar to the method described above except as noted below. The steps of the second preferred embodiment are preferably substantially similar to Steps S110, S120, S130, and S140 respectively except as noted below. The second preferred embodiment preferably uses a single instance of a detected object for detecting a gesture. For example, the detection of a user making a hand gesture (e.g., a thumbs up) can preferably be used to generate an input command. Similar to how input gestures have associated patterns, an input gesture may be associated with a single detected object. Step S140 in this embodiment is preferably only dependent on identifying a detected gesture object orientation to a command. This process of gesture detection may be used along with the first preferred embodiment such that a single gesture detection process may be used to detect object orientation changes, sequence of appearance of physical objects, sustained duration of a single object, and single instance presence of objects. Any variations of the preferred embodiment can additionally be used with the second preferred embodiment.

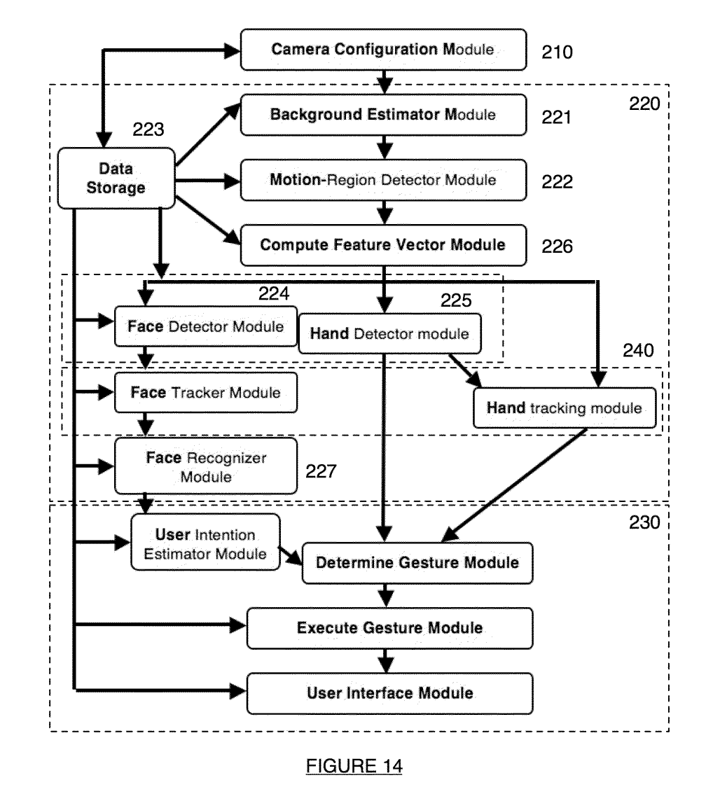

As shown in FIG. 14, system for detecting user interface gestures of a preferred embodiment includes a system including an imaging unit 210, an object detector 220, and a gesture determination module 230. The imaging unit 210 preferably captures the images for gesture detection and preferably performs the steps substantially similar to those described in S110. The object detector 220 preferably functions to output identified objects. The object detector 220 preferably includes several sub-modules that contribute to the detection process such as a background estimator 221, a motion region detector 222, and data storage 223. Additionally, the object detector preferably includes a face detection module 224 and a hand detection module 225. The object detector preferably works in cooperation with a compute feature vector module 226. Additionally, the system may include an object tracking module 240 for tracking hands, a face, or any suitable object. There may additionally be a face recognizer module 227 that determines a user identity. The system preferably implements the steps substantially similar to those described in the method above. The system is preferably implemented through a web camera or a digital camera integrated or connected to a computing device such as a computer, gaming device, mobile computer, or any suitable computing device.

An alternative embodiment preferably implements the above methods in a computer-readable medium storing computer-readable instructions. The instructions are preferably executed by computer-executable components preferably integrated with a imaging unit and a computing device. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for detecting user interface gestures comprising:
obtaining images from an imaging unit;
identifying object search area of the images;
detecting at least a first gesture object in the search area of an image of a first instance;
detecting at least a second gesture object in the search area of an image of at least a second instance; and
determining an input gesture from an occurrence of the first gesture object and the at least second gesture object.

2. The method of claim 1, wherein identifying object search area includes identifying background regions of image data and excluding background from the object search area.

3. The method of claim 1, wherein the imaging unit is a single RGB camera capturing a video of two-dimensional images.

4. The method of claim 1, wherein the first gesture object and the second gesture object are both characterized as hand images; wherein the first gesture object is particularly characterized by an image of a hand in a first configuration and the second gesture object is particularly characterized by an image of a hand in a second configuration.

5. The method of claim 1, further comprising computing feature vectors from the images, wherein detecting a first gesture object and detecting a second gesture object are computed from the feature vectors.

6. The method of claim 5, wherein detecting at least a first gesture object includes detecting a hand object and detecting a face object, wherein detection of the hand object and the face object are computed from the same feature vectors.

7. The method of claim 6, further comprising determining a operation status of at least two processing units and transitioning operation of the steps of identifying object search area, detecting at least a first gesture object, detecting at least a second gesture, and determining an input gesture to the lowest operation status of the at least two processing units.

8. The method of claim 7, wherein transitioning operation includes transitioning operation between a central processing unit and a graphics processing unit.

9. The method of claim 1, wherein detecting a first gesture object includes detecting at least a hand object and a face object.

10. The method of claim 9, wherein determining input gesture includes augmenting the input based on a detected face object.

11. The method of claim 10, wherein a first orientation of a face object augments the input by canceling gesture input from a hand object, and a second orientation of a face object augments the input by enabling the gesture input from a hand object.

12. The method of claim 10, further comprising identifying a user from a face object, and applying personalized determination of input.

13. The method of claim 12, wherein applying personalized determination of input includes retrieving user specific object data of the identified user, wherein detection of the first gesture object and the second gesture object use the user specific object data.

14. The method of claim 12, wherein applying personalized determination of input includes enabling inputs allowed in a user permissions profile of the user.

15. The method of claim 10, wherein a mood of the user is a configuration of the face object detected, wherein augmenting the input includes selecting an input mapped to a detected hand gesture and a detected mood configuration of the face object.

16. The method of claim 1, further comprising tracking the object motion; wherein determining the input gesture includes selecting a gesture input corresponding to the combination of tracked motion and object transition.

17. The method of claim 16, wherein detection of a first gesture object includes detecting a hand in a configuration associated with multi-dimensional input, and wherein determining gesture input includes using tracked motion of the hand as multi-dimensional cursor input.

18. The method of claim 17, wherein the tracked motion of the hand is used for key entry through the motion of the hand.

19. The method of claim 1, wherein the input gesture is configured for altering operation of a computing device.

20. The method of claim 1, wherein the object is a face object; further comprising displaying an advertisement on a display, and gesture input is an attention input for the advertisement.

21. The method of claim 1, wherein the occurrence of the first gesture object and the at least second gesture object is selected from the group consisting of a pattern for a transitioning sequence of different gesture objects, a pattern of at least two discreet occurrence of different gesture objects, and a pattern where the first and at least second gesture object are associated with the same orientation of an object.
